(19) United States
(12) Patent Application Publication
(10) Pub. No.: US 2025/0222627 A1
(43) Pub. Date: Jul. 10, 2025

(54) AUTOMATIC STROKE SETTING APPARATUS OF CUTTING DEVICE USING MULTI-WIRE

(71) Applicant: HANWHA PRECISION MACHINERY CO., LTD., Changwon-si (KR)

(72) Inventors: Min Su KIM, Changwon-si (KR); Jae Hyeok LEE, Changwon-si (KR)

(73) Assignee: HANWHA PRECISION MACHINERY CO., LTD., Changwon-si (KR)

(21) Appl. No.: 19/088,309

(22) Filed: Mar. 24, 2025

Related U.S. Application Data
(63) Continuation of application No. PCT/KR2023/013482, filed on Sep. 8, 2023.

(30) Foreign Application Priority Data
Sep. 5, 2023 (KR) 10-2023-0117535

(51) Int. Cl. B28D 5/00; B28D 5/04

(52) U.S. Cl. CPC B28D 5/0064; B28D 5/042

(57) ABSTRACT

An apparatus configured to automatically set a stroke range of a cutting device includes: a driver including a rotary shaft on which a bobbin is detachably mounted; a traverse configured to move an attachment point of a wire with respect to the bobbin; and a sensor configured to measure a distance between the driver and the bobbin. The apparatus further includes a controller configured to adjust the stroke range of the traverse to move in parallel based on the distance measured by the sensor. The sensor is configured to measure, as first distance data, a distance between a side of the driver and a side of the bobbin.

### CROSS REFERENCE TO RELATED APPLICATION

This application is a continuation of International Application No. PCT/KR2023/013482, filed on Sep. 8, 2023, in the Korean Intellectual Property Receiving Office, which is based on and claims priority to Korean Patent Application No. 10-2023-0117535, filed on Sep. 5, 2023, in the Korean Intellectual Property Office, the disclosures of which are incorporated herein by reference in their entireties.

### 1. FIELD

This disclosure relates to an automatic stroke setting apparatus for a cutting device using a multi-wire, and more particularly, to an automatic stroke setting apparatus for a cutting device using a multi-wire that allows for easy identification of the position displacement of a replaced bobbin on which the wire is wound, and thereby enables the correction of the stroke position of a traverse.

### 2. DESCRIPTION OF RELATED ART

In semiconductor processes, silicon wafers, sapphire wafers, and quartz wafers (or subsidiary elements), as well as silicon parts (or subsidiary elements), are typically cut from larger specimens using a multi-wire.

For example, a wafer is a sheet made from silicon, which is widely used as a material for manufacturing semiconductor devices. The wafer is produced through a series of processes: a slicing process that cuts a grown silicon ingot into wafer form, a lapping process to even out and flatten the thickness of the wafer, an etching process to remove or mitigate damages caused by mechanical polishing, a polishing process to smoothen the surface of the wafer, and a cleaning process to wash the polished wafer and remove contaminants attached to the surface of the wafer. Among these, the slicing process involves grinding the outer surface of a silicon single-crystal ingot to form a cylinder of predetermined dimensions, and then cutting the cylinder into individual wafers.

Various types of slicing devices are generally used for the slicing process, one of which is a wire saw device. The wire saw device cuts a material by bringing wire into contact with the material and rapidly generating friction between the wire and the material. Since this type of wire saw device can simultaneously cut an ingot into multiple wafers, it is widely used due to its excellent production rate per unit time.

Recently, methods that involve coating the wire with diamond and using it for cutting products are being increasingly utilized.

The wire saw device is equipment that performs processing by winding and unwinding the wire on a rotating body while maintaining a constant tension and necessitates the periodic replacement of a bobbin that supplies and retrieves the wire.

However, the bobbin is usually manually replaced by the operator, and depending on the operator's skill level, displacement may occur in the mounting position of the bobbin. This changes the unwinding point of a traverse, which releases the wire from or supplies the wire to the bobbin within the bobbin's stroke range, leading to problems in precisely winding or unwinding the wire.

### SUMMARY

To address the aforementioned problems, provided is an automatic stroke setting apparatus for a cutting device using a multi-wire that allows for easy identification of the position displacement of a replaced bobbin on which wire is wound, and thereby enables the correction of the stroke position of a traverse.

Additional aspects will be set forth in part in the description which follows and, in part, will be apparent from the description, or may be learned by practice of the presented embodiments.

According to an aspect of an embodiment, an apparatus configured to automatically set a stroke range of a cutting device may include: a driver including a rotary shaft on which a bobbin is detachably mounted; a traverse configured to move an attachment point of a wire with respect to the bobbin; and a sensor configured to measure a distance between the driver and the bobbin.

The apparatus may further include a controller configured to adjust the stroke range of the traverse to move in parallel based on the distance measured by the sensor.

The sensor may be configured to measure, as first distance data, a distance between a side of the driver and a side of the bobbin, where, in a state in which the bobbin is replaced with another bobbin, the sensor is configured to measure, as second distance data, a distance between the side of the driver and a side of the another bobbin, and transmit the first distance data and the second distance data to the controller.

The controller may include a memory configured to store the first distance data and the second distance data provided by the sensor.

The sensor may be disposed to face the side of the bobbin on the side of the driver.

The controller may be configured to compare the first distance data and the second distance data transmitted to the memory of the controller and obtain an offset based on a distance variation between the first distance data and the second distance data.

The controller may be configured to set an average value of the distance variation between the first distance data and the second distance data stored in the memory as the offset.

The controller may be configured to set a maximum value of the distance variation between the first distance data and the second distance data stored in the memory as the offset.

The apparatus may further include a cover disposed on the driver, configured to protect the sensor and configured to transition between an open state and a closed state.

The sensor may be configured to transmit a distance sensing signal in a direction parallel to the rotary shaft.

The cutting device may be using a multi-wire.

According to an aspect of an embodiment, an apparatus configured to automatically set a stroke range of a cutting device may include: a driver including a rotary shaft on which a bobbin is detachably mounted; a traverse configured to move an attachment point of a wire with respect to the bobbin; a sensor configured to measure, as first distance data, a distance between the driver and the bobbin, where, in a state in which the bobbin is replaced with another bobbin, the sensor measures, as second distance data, a distance between the driver and the another bobbin; and a controller configured to adjust a stroke range of the traverse by an obtained offset, where the controller is configured to obtain the offset based on a distance variation between the first distance data and the second distance data.

The controller may include a memory configured to store the first distance data and the second distance data.

The controller may be configured to set an average value of the distance variation between the first distance data and the second distance data as the offset.

The controller may be configured to set a maximum value of the distance variation between the first distance data and the second distance data as the offset.

The apparatus may further include a cover configured to protect the sensor and configured to transition between an open state and a closed state.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a front view illustrating an automatic stroke setting apparatus for a cutting device using a multi-wire according to an embodiment;

FIG. 2 is a block diagram illustrating the automatic stroke setting apparatus for a cutting device using a multi-wire according to an embodiment;

FIG. 3 is a cross-sectional view illustrating the automatic stroke setting apparatus of FIG. 1 with a first bobbin mounted therein according to an embodiment;

FIG. 4 is a cross-sectional view illustrating the automatic stroke setting apparatus of FIG. 1 with the first bobbin replaced with a second bobbin according to an embodiment;

FIG. 5 is a cross-sectional view illustrating a state in which the traverse has moved in parallel by a distance corresponding to offset data based on a distance variation from the replacement of the first bobbin with the second bobbin.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

Terms that include ordinals such as “first,” “second,” etc., may be used to describe various components, but the components are not limited by these terms.

These terms are used only to distinguish one component from another.

For example, without departing from the scope of the present invention, a second component may be termed a first component, and similarly, a first component may be termed a second component.

The term “and/or” includes any combination of the listed related items or any of the related items.

When it is mentioned that one component is “connected to” or “coupled with” another component, it should be understood that it may be directly connected or coupled to the other component, or there may be another component in between.

On the other hand, when it is mentioned that one component is “directly connected to” or “directly coupled with” another component, it should be understood that there are no other components in between.

The terms used in this application are only for describing particular embodiments and are not intended to limit the disclosure.

Singular expressions, unless explicitly stated otherwise in context, include plural expressions.

In this application, terms like “include” or “have” are used to indicate the existence of the features, numbers, steps, operations, components, parts, or combinations thereof stated in the specification, and do not preclude the existence or addition of one or more other features, numbers, steps, operations, components, parts, or combinations thereof.

Embodiments of the present disclosure will hereinafter be described with reference to the accompanying drawings. The same reference numerals are assigned to identical or corresponding components, regardless of the drawing numbers, and redundant descriptions thereof are omitted.

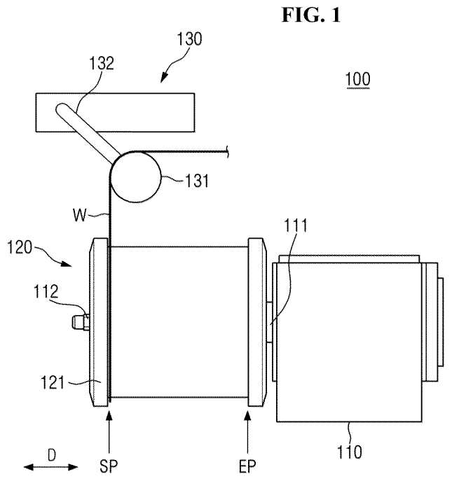

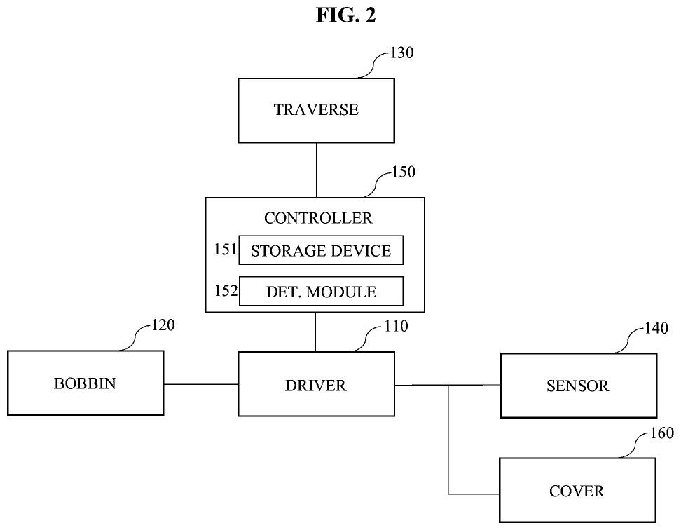

FIG. 1 is a front view illustrating an automatic stroke setting apparatus for a cutting device using a multi-wire according to an embodiment of the present invention, and FIG. 2 is a block diagram illustrating the automatic stroke setting apparatus for a cutting device using a multi-wire according to an embodiment of the present invention.

Referring to FIGS. 1 and 2, an automatic stroke setting apparatus 100 may be configured to unwind or wind wire wound on bobbins that are placed side by side on both sides by rotating the bobbins. In this case, structures for rotating the bobbins on both sides are the same, so a detailed explanation will be given for one of the structures.

The automatic stroke setting apparatus 100 may have a structure where the wire is unwound (e.g. pulley 131) from one of the bobbins and wound onto another bobbin.

The automatic stroke setting apparatus 100 may include a driver 110, a bobbin 120, a traverse 130, a sensor 140, a controller 150, and a cover 160.

The driver 110 may be characterized as a motor, including at least one stator and at least one rotor, configured to convert electrical energy into rotational mechanical energy. The driver 110 may include a rotary shaft 111. The driver 110 may provide a driving force to rotate the rotary shaft 111. The bobbin 120 may be detachably coupled on the rotary shaft 111 and may rotate simultaneously in the direction of rotation of the rotary shaft 111.

For example, when the driver 110 rotates the rotary shaft 111 in a forward direction, cutting may occur as a wire W wound on one bobbin moves to another bobbin. Conversely, as the wire W wound on one bobbin moves to another bobbin, cutting may occur or rewinding of the wire may take place.

Moreover, the wire W is wound on the outer surfaces of the bobbins, and the wire W may be unwound by pulley 131 or wound by the rotation of the rotary shaft 111.

The bobbin 120 has a start point SP from which the wire unwinds or winds in a direction relative to an axial direction, and an end point EP, which is opposite to the start point SP and where the wire unwinds or winds in another direction, and the range between the start point SP and the end point EP may be set as a stroke range.

The start point SP and the end point EP of the bobbin 120 may be set by protrusions 121, which extend circumferentially from both ends of the bobbin 120. The protrusions 121 may prevent the wire from escaping from the outer surface of the bobbin and may also limit the height at which the wire W winds on the outer surface of the bobbin 120.

The bobbin 120 is fastened on the rotary shaft 111 by a bolt 112, and a predetermined assembly tolerance may occur depending on the fastening torque of the bolt 112. Alternatively, the bobbin may be coupled at a predetermined inclination angle with respect to the rotary shaft 111 in the process of fastening the bobbin to the rotary shaft 111.

Also, the traverse 130 is disposed to enable linear reciprocating movement along an axial direction D and may supply the wire W to the bobbin 120 in a direction orthogonal to the axial direction D of the bobbin 120. In other words, the traverse 130 may move such that the point where the wire W is unwound always corresponds to the circumferential direction of the bobbin 120, and accurate direction changes may occur at the start and end points of the bobbin 120.

The traverse 130 may include a pulley 131, which guides the wire W at its unwound point, and an arm 132, which moves the pulley 131 in point-symmetry about a single rotation center. That is, the pulley 131 may approach or move away from the bobbin 120 due to the rotation of the arm 132 and may thereby move along the circumferential direction of the bobbin 120 to correspond to the height at which the wire W is wound.

Also, the sensor 140 may measure the distance between the bobbin 120 and the driver 110. For example, the sensor 140 may be disposed in an area facing one side of the bobbin 120, on the driver 110. The sensor 140 may also be disposed on the outside of the driver 110 to measure the distance between the bobbin 120 and the driver 110. In the present embodiment, for example, the sensor 140 may be provided on the driver 110.

The sensor 140 may perform distance measurements through a contact or non-contact method. In the present embodiment, for example, the sensor 140 may precisely measure the distance between the bobbin 120 and the driver 110 through a non-contact method. For example, the sensor 140 may use a non-contact sensor such as an ultrasonic sensor, an infrared sensor, a camera, etc.

Also, the controller 150 may receive distance data from the sensor 140 and may control the stroke range of the traverse 130 to be moved in parallel. That is, while maintaining the set stroke range, the controller 150 may adjust the stroke position of the traverse 130. For example, when a displacement occurs in the position where the bobbin is mounted on the rotary shaft 111, the controller 150 may receive data corresponding to the displacement from the sensor 140 and may move the unwinding point of the traverse 130 in parallel along the axial direction by as much as the displacement.

The controller 150 may include a storage device 151, which stores the distance data provided by the sensor 140. The storage device 151 can store the first distance data for one bobbin and the second distance data for another replaced bobbin. The storage device 151 may include a plurality of memory modules. Alternatively or additionally, the storage device may be an external memory device, a hard disk, and/or an optical disk, a cloud storage, not being limited thereto, and may be connected to the controller 150 wiredly or wirelessly.

Also, the controller 150 may include a determination module 152, which compares the first distance data and the second distance data to derive offset data based on a variation in distance. The offset data may be distance information that allows the traverse 130 to move in parallel in response to the distance variation. The controller 150 may be physically implemented by analog and/or digital circuits including one or more of a logic gate, an integrated circuit, a microprocessor, a system-on-chip (SoC), a microcontroller, a memory circuit, a passive electronic component, an active electronic component, an optical component, and the like, and may implement or execute software and/or firmware to perform the functions or operations described herein. The determination module may be implemented by one or more software modules and/or firmware.

Also, the sensor 140 may measure multiple first distance data and second distance data and may store the first distance data and the second distance data in the storage device 151. The sensor 140 may measure the first distance d1 multiple times while rotating a first bobbin 120, and may also measure the second distance d2 multiple times while rotating a second bobbin 120′.

Also, the determination module 152 may derive an average value as the distance variation using each stored distance data in the storage device 151, and may thereby set the offset based on the average value.

Also, the determination module 152 may derive a maximum value as the distance variation using each stored distance data in the storage device 151, and may thereby set the offset based on the maximum value.

The cover 160 may take of a form of shield, shroud or support structure configured as a protective measure to shield the sensor from debris and other external environmental factors that may interfere with the sensor. The cover 160 may prevent foreign materials generated at a process location where a cutting process takes place from contaminating the sensor 140. In the present embodiment, since the sensor 140 is provided on the driver 110, the cover 160 may also be provided on the driver 110 and may selectively open the area of the sensor 140 during a measurement process. The cover 160 may be mounted on the driver 110 in a sliding or swinging manner. If the sensor 140 is applied in a contact method, a structure where the cover 160 is opened and the sensor 140 protrudes from a side of the driver 110 may also be applied.

The controller 150 may not only adjust the position of the traverse 130 but also control the rotation speed and direction of the driver 110, the replacement timing of the bobbin 120, and the overall operation of the sensor 140 and the cover 160.

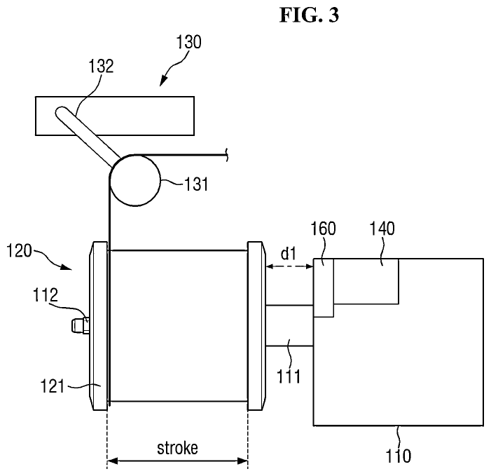

FIG. 3 is a cross-sectional view illustrating the automatic stroke setting apparatus of FIG. 1 with the first bobbin mounted therein.

Referring to FIG. 3, the first bobbin 120 is mounted on the rotary shaft 111 of the driver 110, and the sensor 140 is mounted on the driver 110, facing one side of the first bobbin 120. The sensor 140 may be shielded by the cover 160 and may be opened during distance measurement.

In FIGS. 3 through 5, the rotary shaft 111 is illustrated as being exposed more than it actually is to represent variations in the distance between the bobbin and the driver 110. The actual distance between the bobbin and the driver 110 may be as illustrated in FIG. 1.

The wire W may be wound on the first bobbin 120 within a predetermined-set stroke range, and the first bobbin 120 may be driven at a distance corresponding to the first distance data apart from the driver 110.

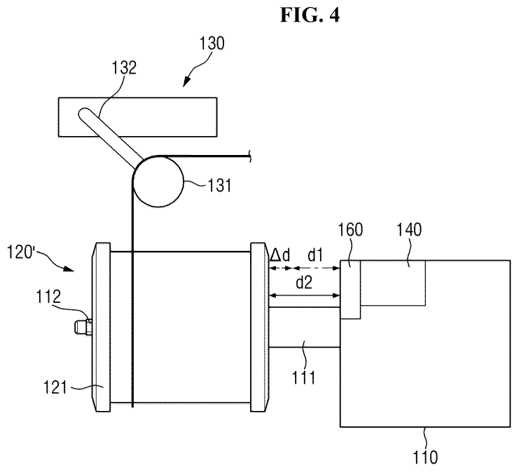

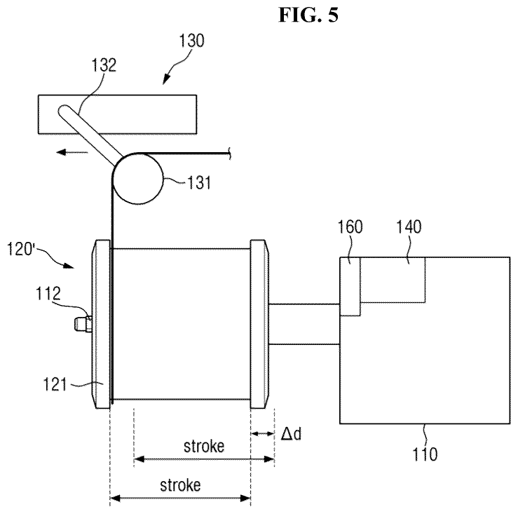

FIG. 4 is a cross-sectional view illustrating the automatic stroke setting apparatus of FIG. 1 with the first bobbin replaced with the second bobbin, and FIG. 5 is a cross-sectional view illustrating a state in which the traverse has moved in parallel by a distance corresponding to offset data based on a distance variation from the replacement of the first bobbin with the second bobbin.

Referring to FIGS. 4 and 5, when the first bobbin 120 is removed and replaced with the second bobbin 120′, the sensor 140 measures the distance to the second bobbin 120′, indicating that the second bobbin 120′ is positioned at a distance corresponding the second distance d2.

That is, if the first bobbin (“120” of FIG. 3) is apart by the distance corresponding to the first distance data d1 and the second bobbin 120′ is apart by the distance corresponding to the second distance data d2, as illustrated in FIG. 4, a distance variation Δd occurs.

Although not illustrated in the drawings, the distance variation Δd may be measured and derived by the controller 150.

Here, the derived distance variation Δd may be applied as offset data for the traverse 130 to move.

For example, if the derived distance variation Δd results in offset data of +0.2 mm, the controller (“150” of FIG. 2) may control the traverse 130 to move 0.2 mm to the left (based on the orientation depicted in FIG. 5) along the axial direction of the rotary shaft 111. Alternatively, if the offset data is −0.1 mm, the controller (“150” of FIG. 2) may control the traverse 130 to move 0.1 mm to the right (based on the orientation depicted in FIG. 5) along the axial direction of the rotary shaft 111.

Therefore, as illustrated in FIG. 5, when the traverse 130 moves in parallel by a distance corresponding to the offset data, the traverse 130 can be precisely aligned to correspond to the stroke range of the second bobbin 120′.

Therefore, the automatic stroke setting apparatus according to the present invention can precisely detect the position displacement of a replaced bobbin on the rotary shaft, automatically correct the stroke position of the traverse in response to the bobbin's position displacement, and prevent contamination of the sensor by foreign materials generated in the cutting device by equipping the cover in front of the sensor.

The automatic stroke setting apparatus for a cutting device using a multi-wire according to the present invention has the following advantages.

First, even if a bobbin is replaced on the rotary shaft, the position displacement of the replaced bobbin can be precisely detected.

Second, the stroke position of the traverse can be automatically corrected in response to the position displacement of the bobbin.

Third, by equipping the cover in front of the sensor, it is possible to prevent contamination of the sensor by foreign materials generated in the cutting device.

The present invention has been described and illustrated through specific embodiments for the purpose of exemplifying the technical idea of the invention. However, the present invention is not limited to the same structure and operation as the specific embodiments described above. Various modifications can be made within the scope of the invention without departing from it. Therefore, such modifications should also be considered within the scope of the invention, and the scope of the invention should be determined by the claims that follow.

What is claimed is:

1. An apparatus configured to automatically set a stroke range of a cutting device comprising:
a driver comprising a rotary shaft on which a bobbin is detachably mounted;
a traverse configured to move an attachment point of a wire with respect to the bobbin; and
a sensor configured to measure a distance between the driver and the bobbin.

2. The apparatus of claim 1, further comprising:
a controller configured to adjust the stroke range of the traverse to move in parallel based on the distance measured by the sensor.

3. The apparatus of claim 2, wherein the sensor is configured to measure, as first distance data, a distance between a side of the driver and a side of the bobbin, and
wherein, in a state in which the bobbin is replaced with another bobbin, the sensor is configured to measure, as second distance data, a distance between the side of the driver and a side of the another bobbin, and transmit the first distance data and the second distance data to the controller.

4. The apparatus of claim 3, wherein the controller comprises a memory configured to store the first distance data and the second distance data provided by the sensor.

5. The apparatus of claim 4, wherein the sensor is disposed to face the side of the bobbin on the side of the driver.

6. The apparatus of claim 4, wherein the controller is configured to compare the first distance data and the second distance data transmitted to the memory of the controller and obtain an offset based on a distance variation between the first distance data and the second distance data.

7. The apparatus of claim 6, wherein the controller is configured to set an average value of the distance variation between the first distance data and the second distance data stored in the memory as the offset.

8. The apparatus of claim 6, wherein the controller is configured to set a maximum value of the distance variation between the first distance data and the second distance data stored in the memory as the offset.

9. The apparatus of claim 1, further comprising a cover disposed on the driver, configured to protect the sensor and configured to transition between an open state and a closed state.

10. The apparatus of claim 1, wherein the sensor is configured to transmit a distance sensing signal in a direction parallel to the rotary shaft.

11. The apparatus of claim 1, wherein the cutting device is using a multi-wire.

12. An apparatus configured to automatically set a stroke range of a cutting device comprising:
a driver comprising a rotary shaft on which a bobbin is detachably mounted;
a traverse configured to move an attachment point of a wire with respect to the bobbin;
a sensor configured to measure, as first distance data, a distance between the driver and the bobbin,
wherein, in a state in which the bobbin is replaced with another bobbin, the sensor is configured to measure, as second distance data, a distance between the driver and the another bobbin; and
a controller configured to adjust the stroke range of the traverse by an offset,
wherein the controller is configured to obtain the offset based on a distance variation between the first distance data and the second distance data.

13. The apparatus of claim 12, wherein the controller comprises a memory configured to store the first distance data and the second distance data.

14. The apparatus of claim 13, wherein the controller is configured to set an average value of the distance variation between the first distance data and the second distance data as the offset.

15. The apparatus of claim 13, wherein the controller is configured to set a maximum value of the distance variation between the first distance data and the second distance data as the offset.

16. The apparatus of claim 12, further comprising a cover configured to protect the sensor and configured to transition between an open state and a closed state.
